(19) United States
(12) Patent Application Publication
(10) Pub. No.: US 2007/0077386 A1
(43) Pub. Date: Apr. 5, 2007

(54) Wrapping paper pad and methods

(76) Inventor: Carol Fertig, New York, NY (US)

Correspondence Address: MERCHANT & GOULD PC, P.O. BOX 2903, MINNEAPOLIS, MN, 55402-0903, US

(21) Appl. No.: 11/313,339

(22) Filed: Dec. 20, 2005

Related U.S. Application Data
(60) Provisional application No. 60/723,847, filed on Oct. 5, 2005.

(51) Int. Cl. G09F 3/00; B32B 23/02

(52) U.S. Cl. 428/43; 428/194; 428/40.1

(57) ABSTRACT

The pad of wrapping paper includes a plurality of individual sheets of paper bound together along at least one edge. Each individual sheet of paper is removable from the plurality of individual sheets of paper along a tear line at the at least one edge. A plurality of the sheets of paper have a decoration or print pattern. At least one individual sheet of paper has a print pattern different from at least one other individual sheet of paper in the plurality of papers. Each individual sheet of paper has a size no greater than 8500 cm². A method of wrapping an item includes tearing an individual sheet of paper along a tear line from a pad of papers bound together along a single edge. A plurality of the sheets of paper have a print pattern. At least one individual sheet of paper has a print pattern different from at least one other individual sheet of paper in the pad of papers. Next, an item is wrapped with the individual sheet of paper torn from the pad. A method of making a pad of wrapping paper includes assembling a stack of individual sheets of paper. Each individual sheet has at least one straight edge, and a size no greater than 8500 cm². A plurality of the sheets have a print pattern. At least one individual sheet of paper has a print pattern different from at least one other individual sheet of paper. Next, the stack is aligned along the at least one straight edge of each individual sheet. Next, the individual sheets of paper are secured to each other along each individual sheet's straight edge to form a pad.

This application claims priority under 35 U.S.C. § 119(e) to U.S. provisional patent application Ser. No. 60/723,847, filed Oct. 5, 2005. The complete disclosure of application Ser. No. 60/723,847 is incorporated herein by reference.

### TECHNICAL FIELD

This disclosure concerns wrapping paper, especially the type used for wrapping gifts. In particular, this disclosure concerns a pad of wrapping paper, methods of using, and methods of making.

### BACKGROUND

Wrapping paper that is used for enclosing gifts is usually provided in the form of a continuous roll of paper or folded into a rectangle or square. Wrapping paper on rolls can be difficult to handle and store. A scissors is needed to cut the paper to the desired size. Wrapping paper that is provided in a folded rectangle has unsightly creases from the fold line. These creases can detract from the ornamental and visual quality of the wrapped item. In addition, wrapping paper folded in a rectangle often requires a scissors to adjust the paper to the desired size.

Thus, it can be appreciated that improvements are desirable.

### SUMMARY OF THE DISCLOSURE

A pad of wrapping paper is provided. The pad of wrapping paper includes a plurality of individual sheets of paper bound together along at least one edge. Each individual sheet of paper is removable from the plurality of individual sheets of paper along a tear line at the at least one edge. A plurality of the individual sheets of paper have a decoration or print pattern. At least one individual sheet of paper has a print pattern different from at least one other individual sheet of paper in the plurality of papers. Each individual sheet of paper has a size no greater than 8500 cm².

In another aspect, a method of wrapping an item is provided. The method includes tearing an individual sheet of paper along a tear line from a pad of papers bound together along a single edge. A plurality of the individual sheets of paper have a print pattern. At least one individual sheet of paper has a print pattern different from at least one other individual sheet of paper in the pad of papers. Next, an item is wrapped with the individual sheet of paper torn from the pad.

In another aspect, a method of making a pad of wrapping paper is provided. The method includes assembling a stack of individual sheets of paper. Each individual sheet has at least one straight edge, and a size no greater than 8500 cm². A plurality of the papers have a print pattern. At least one individual sheet of paper has a print pattern different from at least one other individual sheet of paper. Next, the stack is aligned along the at least one straight edge of each individual sheet. Next, the individual sheets of paper are secured to each other along each individual sheet's straight edge to form a pad.

### BRIEF DESCRIPTION OF THE DRAWINGS

FIG. 1 is a perspective view of a pad of wrapping paper constructed according to principles of this disclosure; and

FIG. 2 is a side elevational view of the pad of wrapping paper depicted in FIG. 1.

### DETAILED DESCRIPTION

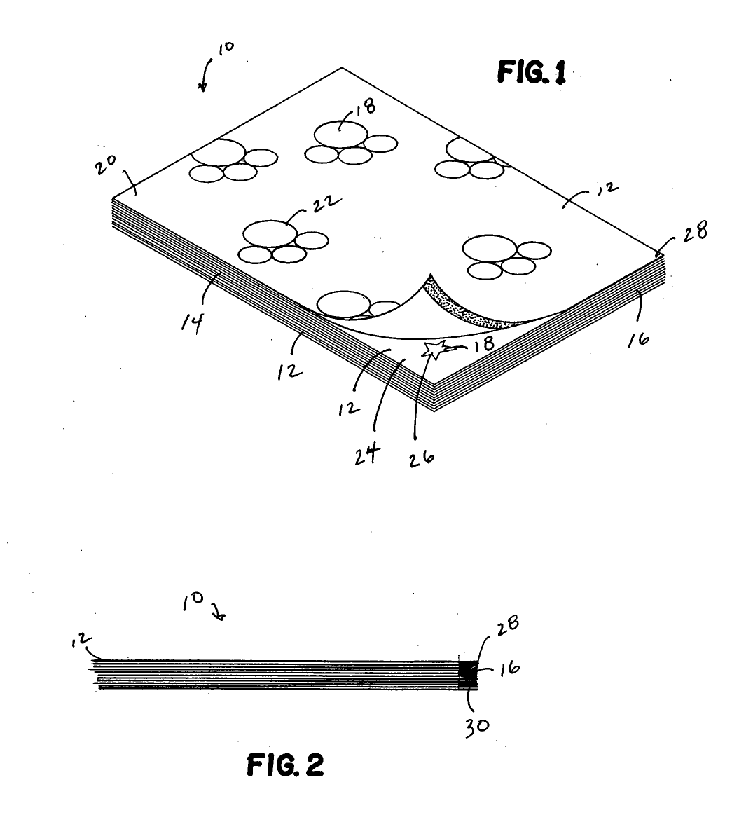

FIG. 1 depicts a pad of wrapping paper 10. The pad of wrapping paper 10 includes a plurality of individual sheets of paper 12 arranged in a stack 14. The individual sheets 12 are bound together along at least one edge 16. In the embodiment shown, the pad 10 is bound along only a single edge 16. It is envisioned that in other embodiments, the individual sheets of paper 12 could be bound together along more than a single edge.

Each individual sheet of paper 12 is of the size and quality desirable for wrapping paper. For example, useful paper for pad 10 includes paper having a weight of at least 10 g/m². Each individual sheet of paper 12 has a weight that will usually be less than 100 g/m². Typical useful weights for each sheet of paper will be 50-90 g/m². Other weights can be used.

Each individual sheet of paper 12 will have a size that is relatively easy to manipulate or handle. For example, useful sizes will be typically not greater than 8500 cm². Preferably, each individual sheet of paper will have a size of between 225 cm² and 6000 cm². Other sizes can be used. Useful sizes include: 20 in.×30 in. (50.8 cm×76.2 cm); 18 in.×24 in. (45.7 cm×61 cm); and 13 in.×9 in. (33 cm×22.9 cm). Preferably, the sizes will be between 700 cm² and 4000 cm².

In the embodiment shown, each individual sheet of paper 12 is rectangular. While shown as rectangular, other embodiments can include other shapes including polygonal, irregular, racetrack-shaped, curvy, etc. It is useful that each individual sheet of paper 12 have at least one straight edge, depicted in FIG. 1 at 16. Having at least one straight edge 16 allows the individual sheets of paper 12 to be easily and conveniently adhered to each other in the form of pad 10.

Each individual sheet of paper 12 has ornamentation, for example, a print pattern 18. As used herein, the “print pattern” 18 can be any decoration, including only a single figure or drawing, including a word, a number, a symbol, etc. Preferably, at least one individual sheet of paper 12 has print pattern 18 that is different from at least one other individual sheet of paper 12 print pattern. For example, in FIG. 1, the top sheet 20 has a particular print pattern 22, while the adjacent sheet 24 has print pattern 26 that is different from print pattern 22. Pad 10 can include a plurality of sheets 12 with print pattern 22 and a plurality of sheets having print pattern 26. Sheets 12 having print pattern 22 can be adjacent to each other or separated from each other. It should be understood that pad 10 can include each individual sheet 12 having a completely different print pattern 18 than any other individual sheet 12. Alternatively, all sheets 12 can have a same print pattern 18 but can be in different colors. In addition, some of the sheets 12 can have print pattern 18 while other sheets can be solid in color. In some embodiments, both sides of the sheet 12 are useable as wrapping paper as both sides will be decorative, possibly including print patterns 18.

In accordance with principles of this disclosure, the pad 10 includes each individual sheet of paper 12 being removable from the plurality of individual sheets 12 along a tear line 28 at the edge 16. A variety of ways can be used to bind the individual sheets of paper 12 together along the edge 16. In the embodiment shown, adhesive binding 30, such as a gummed adhesive, is used. Gummed adhesive 30 allows for easy removal of each individual sheet 12 from the pad 10 without tearing each sheet 12. Other types of binding can be used, including, for example, binding with perforations, scoring, weakened areas, etc.

The pad of wrapping paper 10 can be used to wrap an item. The method includes tearing individual sheet of paper 12 along tear line 28 from the pad 10 bound together along single edge 16. At least one individual sheet of paper has print pattern 18, and at least one individual sheet of paper 12 having print pattern 22 different from at least one other individual sheet of paper 12 in the pad of papers 10. Alternatively, sheets 12 with print patterns 18 can be in the same pad as solid color (no print pattern) sheets or sheets 12 with the same print pattern 18 but in different colors. Next, an item can be wrapped with the individual sheet of paper 12 that was torn from the pad 18. By the word “torn”, it is meant removed from the pad 10 by separating the sheet 12 from the binding 30.

A method of making the wrapping paper pad 10 includes assembling a stack of individual sheets of paper 12. Each individual sheet 12 has at least the one straight edge 16 and a size no greater than 8500 cm². At least one of the individual sheets 12 has a print pattern 18. Next, the stack of papers is aligned along the straight edge 16 and then secured together along the straight edge 16 to form a pad.

The step of assembling preferably includes arranging the individual sheets 12 so that no two adjacent sheets 12 appear identical. The step of assembling can also include arranging the individual sheets of paper 12 so that at least two adjacent sheets are identical. The step of securing can include binding together, for example, using a gummed adhesive to secure the individual sheets 12 to each other along each individual sheet's straight edge 16 to form the pad 10.

What is claimed is:

1. A pad of wrapping paper comprising:
(a) a plurality of individual sheets of paper bound together along at least one edge;
(i) each individual sheet of paper being removable from the plurality of individual sheets of paper along a tear line at the at least one edge;
(b) a plurality of the individual sheets of paper having a print pattern;
(i) at least one individual sheet of paper having a print pattern different from at least one other individual sheet of paper in the plurality of papers; and
(c) each individual sheet of paper having a size no greater than 8500 cm².

2. A pad of wrapping paper according to claim 1 wherein each individual sheet of paper has a rectangular shape.

3. A pad of wrapping paper according to claim 1 wherein each individual sheet of paper has a weight of at least 10 g/m².

4. A pad of wrapping paper according to claim 1 wherein each individual sheet of paper has a weight of 50-90 g/m².

5. A pad of wrapping paper according to claim 1 wherein the plurality of individual sheets of paper are bound together along only a single edge.

6. A pad of wrapping paper according to claim 1 wherein the individual sheets of paper are bound together by an adhesive binding and the tear line is an interface between an individual paper edge and the adhesive binding.

7. A pad of wrapping paper according to claim 1 wherein no two adjacent individual sheets of paper have a same print pattern.

8. A pad of wrapping paper according to claim 1 wherein each individual sheet of paper has a size of between 700 cm² and 4000 cm² inclusive.

9. A method of wrapping an item; the method comprising:
(a) tearing an individual sheet of paper along a tear line from a pad of papers bound together along a single edge; a plurality of individual sheets of paper having a print pattern; at least one individual sheet of paper having a print pattern different from at least one other individual sheet of paper in the pad of papers; and
(b) wrapping an item with the individual sheet of paper torn from the pad.

10. A method according to claim 9 further including before the step of tearing, viewing the individual sheets of paper and selecting an individual sheet of paper based on an appearance of the selected individual sheet of paper.

11. A method according to claim 9 wherein the step of tearing includes tearing the individual sheet of paper from an adhesive binding.

12. A method according to claim 9 wherein the step of tearing an individual sheet of paper from a pad of papers includes tearing from a pad of papers having a size of between 700 cm² and 4000 cm².

13. A method according to claim 9 wherein the step of tearing an individual sheet of paper from a pad of papers includes tearing from a pad of papers having a weight of 50-90 g/m².

14. A method according to claim 9 wherein the step of tearing an individual sheet of paper from a pad of papers includes tearing from a pad of papers wherein no two adjacent individual sheets of paper have a same appearance.

15. A method according to claim 9 wherein the step of tearing an individual sheet of paper from a pad of papers includes tearing from a pad of papers wherein each individual sheet of paper has a rectangular shape.

16. A method of making a pad of wrapping paper; the method comprising:
(a) assembling a stack of individual sheets of paper; each individual sheet having at least one straight edge, and a size no greater than 8500 cm²; a plurality of the sheets of paper having a print pattern; at least one individual sheet of paper having a print pattern different from at least one other individual sheet of paper;
(b) aligning the stack along the at least one straight edge of each individual sheet; and
(c) securing the individual sheets of paper to each other along each individual sheet's straight edge to form a pad.

17. A method according to claim 16 wherein the step of assembling includes arranging the individual sheets of paper so that no two adjacent sheets have a same appearance.

18. A method according to claim 16 wherein the step of assembling includes arranging the individual sheets of paper so that at least two adjacent sheets have a same appearance.

19. A method according to claim 16 wherein the step of assembling includes using individual sheets of paper having a weight of 58-78 g/m², a size of between 700 cm² and 4000 cm², and a rectangular shape.

20. A method according to claim 16 wherein the step of securing includes adhesively securing using a gummed adhesive to secure the individual sheets of paper to each other along each individual sheet's straight edge to form a pad.
